(19) United States
(12) Patent Application Publication
(10) Pub. No.: US 2005/0225532 A1
(43) Pub. Date: Oct. 13, 2005

(54) Big wheel mouse

(76) Inventor: Annie Cheng, Diamond Bar, CA (US)

Correspondence Address: JOE NIEH, 18760 E. AMAR ROAD #204, WALNUT, CA, 91789, US

(21) Appl. No.: 10/823,232

(22) Filed: Apr. 13, 2004

(51) Int. Cl. G09G 5/08

(52) U.S. Cl. 345/163

(57) ABSTRACT

A computer mouse with a big ergonomically shaped scrolling wheel comprising a computer mouse with one or more buttons and a scrolling wheel wherein the scrolling wheel has a concave circumference with small notches around the circumference and with a width approximately that of a human finger.

### BACKGROUND

1. Field of Invention

The present invention relates generally to an ergonomic computer input device. More specifically, the present invention relates to an ergonomic computer mouse.

2. Description of Related Art

Various input devices are used to input information into the computer. Besides the keyboard, one of the most commonly used computer input device is the mouse. Conventional mouse generally has a housing with two or more buttons near one end with a small scrolling wheel between the buttons. The buttons are used to select icons, buttons, and objects on the computer screen. The scrolling wheel is generally used to scroll the viewing window up and down the document or picture to view the document or picture that is larger than one full screen. Under the mouse is a free rolling rubber ball that translates the movement of the mouse into coordinates to control a cursor on the screen. In some of the latest mouse the rubber ball is replaced by an infrared light and sensor. The mouse may be connected to the computer with a cable or wirelessly.

The conventional scrolling wheel on the mouse is a small circular disc with a convex circumference with small notches all around the circumference. The small notches increase the friction between the scrolling wheel and the user's finger to minimized slippage during scrolling. The conventional scrolling wheel is generally rotably affixed between the buttons and at a position slightly higher than the surface of the mouse and the buttons. The user bends and flexes one finger over the top of the small scrolling wheel to roll the scrolling wheel forward or backward thereby moving the viewing window on the computer screen up and down. Since the scrolling wheel circumference is convex and the wheel is affixed higher than the surface of the mouse and the buttons, the user must bend and raise the finger to place it over the top of the scrolling wheel. This bending and raising of the finger increases muscle strain on the finger and results in fatigue after extended use of the mouse. Furthermore, the user must conscientiously maintain the finger over the top edge of the small convex wheel circumference to use the scrolling wheel.

### SUMMARY OF THE INVENTION

The present invention is a computer mouse with a big ergonomically shaped scrolling wheel. The big wheel mouse comprises of a computer mouse with one or more buttons and a scrolling wheel wherein the scrolling wheel has a concave circumference with small notches around the circumference and with a width approximately that of a human finger. The big wheel mouse of the present invention is ergonomically designed for extended use and to minimize fatigue of the finger on the scrolling wheel.

### BRIEF DESCRIPTION OF THE DRAWINGS

FIG. 1 shows the conventional mouse with a small convex scrolling wheel.

FIG. 2 shows the preferred embodiment of the big wheel mouse of the present invention.

### DETAILED DESCRIPTION OF THE PREFERRED EMBODIMENT

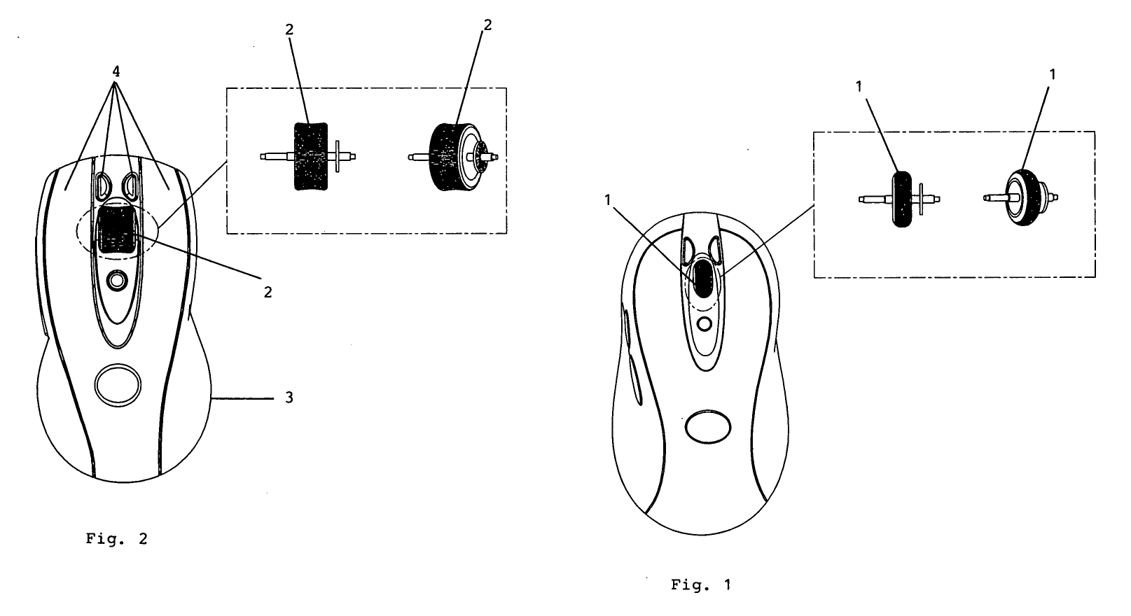

FIG. 1 shows the prior art of the computer mouse. The scrolling wheel 1 on the conventional mouse is a small circular disc with a convex circumference with small notches all around the circumference. Since the scrolling wheel circumference is convex and the scrolling wheel 1 is affixed higher than the surface of the mouse and the buttons, the user must bend and raise the finger to place it over the top of the scrolling wheel 1. This bending and raising of the finger increases muscle strain on the finger and results in fatigue after extended use of the mouse. The user must also conscientiously maintain the finger over the top edge of the small convex wheel circumference to use the scrolling wheel 1.

FIG. 2 shows the preferred embodiment of the present invention. In the preferred embodiment, the big wheel mouse has a big ergonomically shaped scrolling wheel 2. The big wheel mouse comprises a computer mouse 3 with one or more buttons 4 and a big scrolling wheel 2 wherein the scrolling wheel 2 has a concave circumference with small notches around the circumference and with a width approximately that of a human finger. The diameter of the scrolling wheel 2 is larger than the diameter of the scrolling wheel 1 on a conventional mouse.

The user of the big wheel mouse need to merely rest a finger in the large concave surface on the big scrolling wheel 2 and move the finger back and forth over the big scrolling wheel 2 to easily rotate the scrolling wheel 2. Between scrolling, the user only has to rest the finger in the comfortable concave surface on the circumference of the big scrolling wheel 2 without any strain on the muscles in the finger. Since the circumference of the big scrolling wheel 2 is concave, it cradles the finger and the user does not have to conscientiously maintain the finger on top of the big scrolling wheel 2. Also, the concave surface places the user's finger closer to the same plane as the other fingers on the mouse 3 to further reduce any muscle strain and fatigue.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

1. A big wheel mouse comprising a computer mouse with one or more buttons and a big ergonomically shaped scrolling wheel wherein the scrolling wheel has a concave circumference.

2. A big wheel mouse as in claim 1, wherein said scrolling wheel further comprises of small notches around the circumference.

3. A big wheel mouse as in claim 1, wherein said scrolling wheel has a width approximately that of a human finger.

4. A big wheel mouse as in claim 1, wherein said scrolling wheel has a larger diameter than a conventional scrolling wheel.

5. A big wheel mouse as in claim 2, wherein said scrolling wheel has a width approximately that of a human finger.

6. A big wheel mouse as in claim 3, wherein said scrolling wheel has a width approximately that of a human finger.

7. A big wheel mouse as in claim 4, wherein said scrolling wheel has a width approximately that of a human finger.

8. A big wheel mouse as in claim 2, wherein said scrolling wheel has a larger diameter than a conventional scrolling wheel.

9. A big wheel mouse as in claim 3, wherein said scrolling wheel has a larger diameter than a conventional scrolling wheel.

10. A big wheel mouse as in claim 5, wherein said scrolling wheel has a larger diameter than a conventional scrolling wheel.

11. A big wheel mouse as in claim 6, wherein said scrolling wheel has a larger diameter than a conventional scrolling wheel.

12. A big wheel mouse as in claim 7, wherein said scrolling wheel has a larger diameter than a conventional scrolling wheel.
